(19) United States
(12) Patent Application Publication
(10) Pub. No.: US 2023/0385563 A1
(43) Pub. Date: Nov. 30, 2023

(54) Smart Tool Board Device

(71) Applicants: Rodney Kerns, Oxford, NC (US); Andrew Kerns, Oxford, NC (US)

(72) Inventors: Rodney Kerns, Oxford, NC (US); Andrew Kerns, Oxford, NC (US)

(21) Appl. No.: 18/161,363

(22) Filed: Jan. 30, 2023

Related U.S. Application Data
(60) Provisional application No. 63/347,053, filed on May 31, 2022.

(51) Int. Cl. G06K 7/10; G06K 19/077

(52) U.S. Cl. CPC G06K 7/10099; G06K 19/07705

(57) ABSTRACT

The present invention relates generally to a smart tool board device that stores at least one tool and ensures said tool is not lost or misplaced during use. At least one RFID reader on the board detects at least one RFID element that is attached to each tool such that the RFID reader can detect when a tool has not been placed back onto the tool board. Once this occurs, the device may communicate to a manufacturing line and/or process to cease the operation of the manufacturing process.

### CROSS-REFERENCE TO RELATED APPLICATION

The present application claims priority to, and the benefit of, U.S. Provisional Application No. 63/347,053, which was filed on May 31, 2022, and is incorporated herein by reference in its entirety.

### FIELD OF THE INVENTION

The present invention relates generally to the field of tool boards. More specifically, the present invention relates to a smart tool board device that stores at least one tool. At least one RFID reader on the board detects at least one RFID element that is attached to each tool such that the RFID reader can detect when a tool has not been placed back onto the tool board. Once this occurs, the device may communicate to a manufacturing line and/or process to cease the operation of the manufacturing process. Accordingly, the present disclosure makes specific reference thereto. Nonetheless, it is to be appreciated that aspects of the present invention are also equally applicable to other like applications, devices, and methods of manufacture.

### BACKGROUND

Ensuring manufacturing personnel are correctly using and tracking company tools can be a frustrating and difficult process. This is because tools are often lost or misplaced. This impacts production and impedes an operation from reaching its most efficient operating state. In addition, tool organization is beneficial to improving both workplace culture and employee safety. Storing tools at the point of use with a smart device will reduce lost tools and increase productivity improving the bottom line.

Therefore, there exists a long-felt need in the art for an improved tool-storing system. There also exists a long-felt need in the art for a smart tool board device that reduces the possibility of tools becoming lost. In addition, there exists a long-felt need in the art for a smart tool board device that is comprised of a manner of notifying users if a tool is lost.

The subject matter disclosed and claimed herein, in one embodiment thereof, comprises a smart tool board device. The tool board stores at least one tool. At least one RFID reader on the board detects at least one RFID element that is attached to each tool. As a result, the RFID reader can detect when a tool has not been placed back onto the tool board. Once this occurs, the device may communicate to a manufacturing line and/or process to cease operation. In addition, the device can communicate with a remote computer and send event data to the computer so a log file can be created that captures all of the pertinent data related to smart tool board operation. This data is logged for future processing by manufacturing staff.

In this manner, the smart tool board device of the present invention accomplishes all of the foregoing objectives and provides an improved tool-storing system. During use, the device reduces the possibility of tools becoming lost by requiring each tool to be put back on the device to ensure the manufacturing process continues. In addition, the device notifies a user if a tool is lost or misplaced by stopping the manufacturing process.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart tool board device. The device can be integrated into a manufacturing flow and manufacturing/production line such that a manufacturing process may cease to occur if all tools are not present on the body of the device. The body is in the form of a tool board. The front wall of the body is comprised of at least one opening that allows at least one tool peg to be removably secured within the opening. The tool peg may be any size, shape, and style of tool peg or tool holder known in the art that can be received by the opening and can secure at least one tool to the body.

The device is also comprised of at least one tool light. In the preferred embodiment, the number of tool lights correspond to the number of tools stored on the device. The tool light is preferably an LED light that illuminates green.

The device is also comprised of at least one “missing tool” light. The light is preferably an LED light that illuminates red. The missing tool light illuminates when at least one tool is not detected on the tool board body. In one embodiment, the light blinks when a tool has been initially removed from its peg. After a threshold amount of time has passed, the light will then illuminate solid.

In addition, the device may be comprised of at least one “RFID detected” light. The light may illuminate (and/or blink) green. The light blinks when any tool is detected via at least one RFID reader of the device.

The device is also comprised of at least one “all tools present” light. The light is preferably an LED light that illuminates green. The light illuminates when all tools are detected on the device. The light may illuminate solidly if all required tools are detected by each RFID reader, otherwise it will blink indicating one or more RFID tools were not detected. The all tools present light may alternatively blink to indicate all tools are present on the device but not all RFID readers are detecting each element. It should be appreciated that each pair of the reader and element have a unique identifier such that each reader can determine if a tool is misplaced (i.e., wherein the reader detects a different element than the element assigned to the reader).

The device is also comprised of one RFID reader that is dedicated for reading administrative RFID tags. This reader is not located in the tool field but is located near the display area. It is like the detection pods, except is does not have a TOF range finder and has no hole located on the front of the pod. Administrative tags contain information about the operator that is about to interact with the smart tool board or info about the type of maintenance operation the line is about to undergo. This data is logged, just like tool data, to assist in future data analysis.

The device is also comprised of at least one RFID element that may be in the form of a sticker, a chip, a key fob, or card that can be placed on the tool. The element is then detected by at least one RFID reader that is positioned under and/or near each peg.

A laser range finder of the device identifies a distance between the reader and the element of each tool. A distance boundary is then assigned to each reader and/or element. When the element is detected within the boundary, the tool is assumed to be placed on the board. When the element is detected outside the boundary, the tool is assumed absent from the board.

The device is also comprised of one RFID reader that is dedicated for reading administrative RFID tags. This reader is not located in the tool field but is located near the display area. This reader does not have a TOF range finder and has no hole located on the front of the pod. Administrative tags contain information about the operator that is about to interact with the smart tool board or info about the type of maintenance operation the line is about to undergo. This data is logged, just like tool data, to assist in future data analysis.

When the light is illuminated (indicating all tools are present on the body), the device outputs a voltage level. The device also closes relay contacts which can be used to allow manufacturing automation equipment connected to and in communication with the device to start manufacturing. The relay contact closure signals are the preferred method used by manufacturing for interfacing the interlock. The voltage level is an optional signal. When the light blinks (indicating all tools are present on the body but at least one tool is misplaced on the wrong peg), the device opens relay contacts and provides an interlock. When the missing tool light is illuminated, the 5V signal is removed and the relay contacts open. This provides an interlocking feature that prevents the operation of a manufacturing line until all tools have been returned to the body.

The device is also comprised of LCD display module which is used to give the operator detailed info, instructions and status during maintenance operations and reports error conditions when necessary. In addition, the device is comprised of a communication interface that can be used to communicate pertinent data back to a remote computer for data logging and analysis.

Accordingly, the smart tool board device of the present invention is particularly advantageous as it provides an improved tool-storing system. During use, the device reduces the possibility of tools becoming lost. In addition, the device notifies a user if a tool is lost or misplaced. In this manner, the smart tool board device overcomes the limitations of existing methods of storing tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a smart tool board device of the present invention in accordance with the disclosed architecture; and

FIG. 2 illustrates a rear view of one potential embodiment of a smart tool board device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved tool-storing system. There also exists a long-felt need in the art for a smart tool board device that reduces the possibility of tools becoming lost. In addition, there exists a long-felt need in the art for a smart tool board device that is comprised of a manner of notifying users if a tool is lost.

The present invention, in one exemplary embodiment, is comprised of a smart tool board device that can be integrated into a manufacturing flow and manufacturing/production line such that a manufacturing process may cease to occur if all tools are not present on a tool board body of the device. The front wall of the body is comprised of at least one opening that allows at least one tool peg to be removably secured within the opening. The tool peg may be any size, shape, and style of tool peg or tool holder known in the art that can be received by the opening and can secure at least one tool to the body.

The device is also comprised of at least one tool light. In the preferred embodiment, the number of tool lights correspond to the number of tools stored on the device. The tool light is preferably an LED light that illuminates green.

The device is also comprised of at least one “missing tool” light. The light is preferably an LED light that illuminates red. The missing tool light illuminates when at least one tool is not detected on the tool board body. In one embodiment, the light blinks when a tool has been initially removed from its peg. After a threshold amount of time has passed, the light will then illuminate solid.

In addition, the device may be comprised of at least one “RFID detected” light. The light may illuminate (and/or blink) green. The light blinks when any tool is detected via at least one RFID reader of the device.

The device is also comprised of at least one “all tools present” light. The light is preferably an LED light that illuminates green. The light illuminates when all tools are detected on the device. The light may illuminate solidly if all required tools are detected by each RFID reader, otherwise it will blink indicating one or more RFID tools were not detected. The all tools present light may alternatively blink to indicate all tools are present on the device but not all RFID readers are detecting each element. It should be appreciated that each pair of the reader and element have a unique identifier such that each reader can determine if a tool is misplaced (i.e., wherein the reader detects a different element than the element assigned to the reader).

The device is also comprised of one RFID reader that is dedicated for reading administrative RFID tags. This reader is not located in the tool field but is located near the display area. It is like the detection pods, except is does not have a TOF range finder and has no hole located on the front of the pod. Administrative tags contain information about the operator that is about to interact with the smart tool board or info about the type of maintenance operation the line is about to undergo. This data is logged, just like tool data, to assist in future data analysis.

Accordingly, the smart tool board device of the present invention is particularly advantageous as it provides an improved tool-storing system. During use, the device reduces the possibility of tools becoming lost. In addition, the device notifies a user if a tool is lost or misplaced. In this manner, the smart tool board device overcomes the limitations of existing methods of storing tools known in the art.

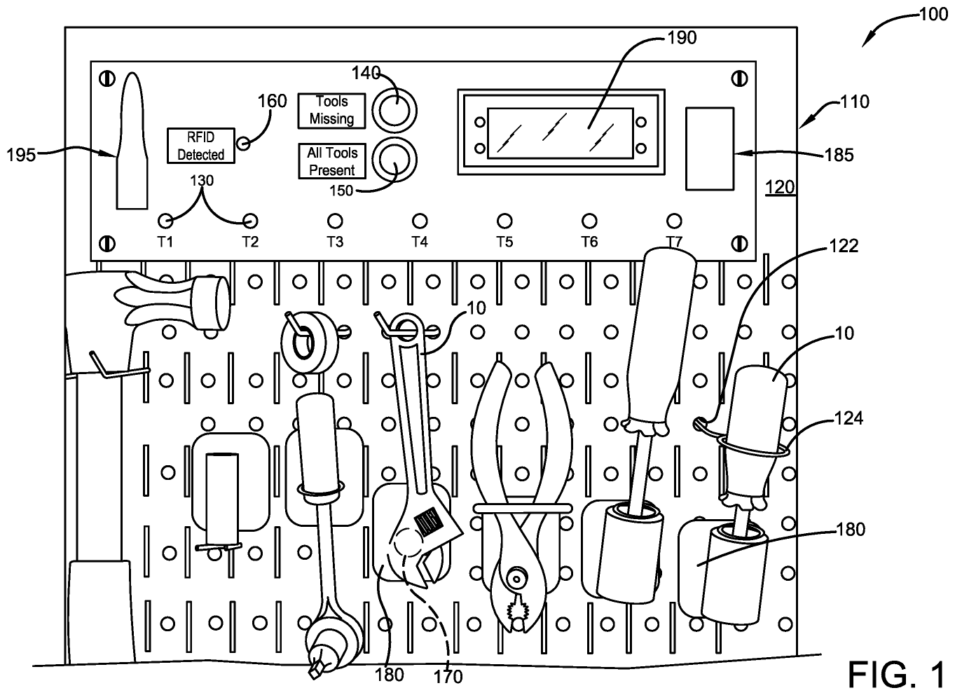

Referring initially to the drawings, FIG. 1 illustrates a front view of one potential embodiment of a smart tool board device 100 of the present invention in accordance with the disclosed architecture. The device 100 can be integrated into a manufacturing flow and manufacturing/production line such that a manufacturing process may cease to occur if all tools 10 are not present on the body 110. Data analytics can be applied to analyze tool usage (recorded by a processor 200) on production lines and worksites. The device is comprised of a body 110 in the form of a tool board. The body 110 is preferably made from a durable metal such as, but not limited to, stainless steel or aluminum. The body 110 may also be made from a rigid plastic material. The body 110 is preferably rectangular or square in shape, but may be any shape known in the art.

The front wall 120 of the body 110 is comprised of at least one opening 122. The opening 122 allows at least one tool peg 124 to be removably secured within the opening 122. In this manner, the tool peg 124 is repositionable across the body 110 to account for a wide variety, shape, and size of tools 10. In another embodiment, the peg 124 is fixedly attached to the body 110. The tool peg 124 may be any size, shape, and style of tool peg or tool holder known in the art that can be received by the opening 122 and can secure at least one tool 10 to the body 110.

The device 100 is also comprised of at least one tool light 130. In the preferred embodiment, the number of tool lights 130 corresponds to the number of tools 10 stored on the device 100. The tool light 130 is preferably an LED light. The light 130 may illuminate any color in the art, but preferably illuminates green. Each tool light 130 may be placed above or near each peg 124.

The device 100 is also comprised of at least one “missing tool” light 140. The light 140 is preferably an LED light that may illuminate any color known in the art. However, the light 140 preferably illuminates red. As will be explained more fully below, the missing tool light 140 illuminates when at least one tool 10 is not detected on the body 110.

In one embodiment, the light 140 blinks when a tool 10 has been initially removed from its peg 124. After a threshold amount of time has passed, the light 140 will then illuminate solid. The threshold amount can be any amount of time (configurable by the user) such as, but not limited to, 15 minutes.

In addition, the device 100 may be comprised of at least one “RFID detected” light 160. The light 160 is preferably an LED light that may illuminate (and/or blink) any color known in the art. However, the light 160 preferably illuminates green. As will be explained more fully below, the light 160 illuminates when all (or at least one) tool 10 is detected via at least one RFID reader 180 of the device 100.

Similarly, the device 100 is comprised of at least one “all tools present” light 150. The light 150 is preferably an LED light that may illuminate any color known in the art. However, the light 150 preferably illuminates green. As will be explained more fully below, the light 150 illuminates when all tools 10 are detected on the device 100. The light 150 may illuminate solid if all tools 10 are detected by each RFID reader 180.

The device 100 is also comprised of at least one RFID element 170. The element 170 may be in the form of a sticker, a chip, a key fob, or card that can be placed on the tool 10. The element 170 is then detected by at least one RFID reader 180 that is positioned under and/or near each peg 124. More specifically, the reader 180 identifies a distance between the reader 180 and the element 170 of each tool 10. A distance boundary is then assigned to each reader 180 and/or element 170. When the element 170 is detected within the boundary, the tool 10 is assumed to be placed on the board 110. When the element 170 is detected outside the boundary, the tool is assumed absent from the board 110. The light 150 may alternatively blink to indicate all tools 10 are present on the device 100 but not all RFID readers 180 are detecting each element 170. It should be appreciated that each pair of reader 180 and element 170 have a unique identifier such that each reader 180 can determine if a tool 10 is misplaced (i.e., wherein the reader 180 detects a different element 170 than the element 170 assigned to the reader 180).

The device 100 is also comprised of at least one display 190. The display 190 is preferably an LCD display, but may be any type of display known in the art. The display 190 indicates information such as, but not limited to, manufacturing line state, lock state, RFID state, and removed tool timer value. During maintenance operation the display 190 also may display information related to InterLock state, missing timer values, and missing RFIDs. During administrative action, the display 190 displays pertinent content of personnel badges, maintenance badges, and threshold values for missing tool timers by way of example.

The device 100 is also comprised of at least one administrative RFID reader 185. The reader 185 is comprised of at least one RFID reader 182. The reader 182 is used to read personnel and maintenance RFID badges. The reader 185 is preferably located near the display 190 but may be located anywhere on the device. This reader does not have a TOF range finder 181 and has no hole located on the front of the pod. Administrative tags contain information about the operator that is about to interact with the device 100 or info about the type of maintenance operation the line is about to undergo. This data is logged to assist in future data analysis.

Administrative tags contain information about the operator that is about to interact with the smart tool board or info about the type of maintenance operation the line is about to undergo. This data is logged, just like tool data, to assist in future data analysis.

In addition, the device may be comprised of at least one Wi-Fi antenna 195 that allows at least one communication interface 196 of the device 100 to communicate via wireless electrical communication. The interface 196 is used to send critical data to a remote computer for data logging. Additionally, one embodiment of the interface 196 is a Wi-Fi interface that can be used to send text messages (SMS) and/or emails to supervisors related to critical maintenance operation events, for example when a threshold timer expires. In one embodiment, the interface is comprised of a CAN BUS interface.

The tool timer value is calculated by at least one processor 200. The processor 200 is in electrical communication with all TOF elements 181 and a timer begins when the first tool has been removed. The timer increases until all tools are in place.

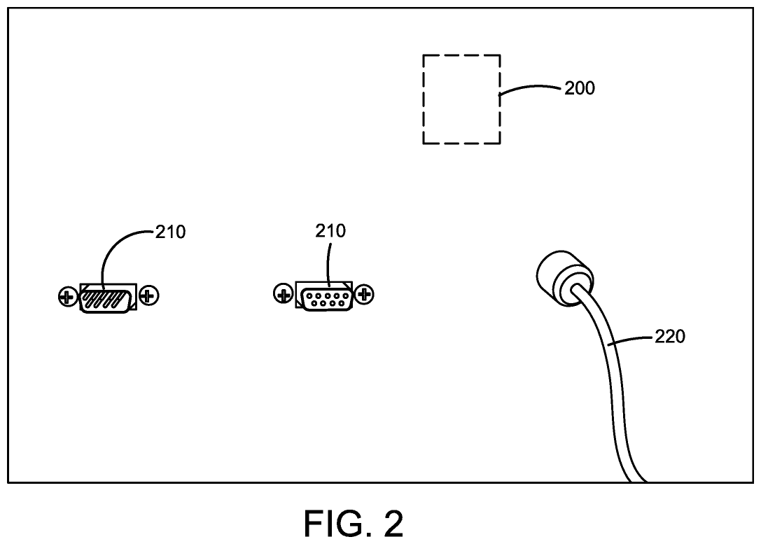

FIG. 2 illustrates a rear view of one potential embodiment of a smart tool board device 100 of the present invention in accordance with the disclosed architecture. The device 100 is also comprised of at least one connector 210. The connector 210 allows the device 100 to be programmed and integrated within a manufacturing line. The connector 210 may be, but is not limited to, a DB-9 female connector. The connector 210 places the device 100 into electrical communication with the manufacturing automation equipment of a manufacturing system. This allows the device 100 to inform the system when all tools 10 are present on the device 100 via electrical signals. Based on input from the device 100 indicating tools 10 are missing from the device 100, the manufacturing line may stop.

More specifically, during use the connector 210 connects to pins 6 and 9 of the interlock DB-9 connector, wherein one pin is an input from the manufacturing equipment the device 100 is in electrical communication with and another pin is an output pin to the manufacturing equipment the device 100 is in electrical communication with. The manufacturing equipment drives one of the pins to a high voltage (typically 10-30 volts). When all tools are detected as present on the device 100, the relay closes and transfers the voltage on the other pin which is read by the manufacturing equipment as a “proceed” signal. If tools are missing and are not detected on the device 100, the relay is open and the output pin is not connected to the high voltage and as a result the manufacturing equipment interprets this lack of voltage as an “inhibit” signal. The device reads the input as reads the input as an “interlock//maintenance enable” and treats the signal as a “maintenance operation can begin “event and reports this event to a remote computer that may comprise or be in communication with the device 100. This is also the signal to the operator (via the display 190) that tools 10 can be removed and the maintenance operation started.

The smart tool board reads the input as an “interlock//maintenance enable” and treats the signal as a “maintenance operation can begin “event and reports this event to the remote computer. This is also the signal to the operator (via the LCD display) that tools can be removed and the maintenance operation started.

The manufacturing equipment drives one of the pins to a high voltage (typically 10-30 volts). When all tools are present the relay closes and puts the voltage on the other pin which is read by the manufacturing equipment as a “proceed” signal. If tools are missing the relay is open and the output pin is not connected to the high voltage and the manufacturing equipment interprets this lack of voltage as an “inhibit” signal.

The smart tool board reads the input as an “interlock//maintenance enable” and treats the signal as a “maintenance operation can begin “event and reports this event to the remote computer. This is also the signal to the operator (via the LCD display) that tools can be removed and the maintenance operation started.

When the light 150 is illuminated (indicating all tools 10 are present on the body 110), the device 100 outputs a voltage level. The voltage level is preferably, but not limited to, a +5V TTL signal. The device 100 also closes relay contacts which can be used to allow manufacturing automation equipment connected to and in communication with the device 100 to start manufacturing. When the light 150 blinks (indicating all tools 10 are present on the body 110 but at least one tool is misplaced on the wrong peg 124), the device 100 opens relay contacts and provides an interlock.

When the missing tool light 140 is illuminated, the 5V signal is removed and the relay contacts open. This provides an interlocking feature that prevents the operation of a manufacturing line until all tools have been returned to the body 110.

The device 100 may be powered by existing power sources within a manufacturing line via at least one electrical wire 220.

The current embodiment of the device 100 uses laser technology for the range finding function. However, any suitable alternate range finding technology could be used such as radar or sonar without departing from the scope of the invention. In addition, the device 100 uses RFID for tool identification. However any suitable identification technology could be used, for example, bar code, QR code, magnetic strip without departing from the scope of the invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart tool board device” and “device” are interchangeable and refer to the smart tool board device 100 of the present invention.

Notwithstanding the foregoing, the smart tool board device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart tool board device 100 as shown in the FIGS. are for illustrative purposes only, and that many other sizes and shapes of the smart tool board device 100 are well within the scope of the present disclosure. Although the dimensions of the smart tool board device 100 are important design parameters for user convenience, the smart tool board device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart tool board device comprising:
a body having an opening;
a first light;
a second light;
a third light;
a display;
an RFID reader;
an RFID element;
a peg;
a connector; and
a processor.

2. The smart tool board device of claim 1, wherein the RFID reader detects the presence of the RFID element.

3. The smart tool board device of claim 1, wherein the body further comprises a tool board.

4. The smart tool board device of claim 1, wherein the first light is a green LED.

5. The smart tool board device of claim 1, wherein the second light is a green LED.

6. The smart tool board device of claim 1, wherein the third light is a red LED.

7. A smart tool board device comprising:
a body having an opening;
a first light comprised of a first color LED;
a second light comprised of a second color LED;
a display;
an RFID reader;
an RFID element;
a peg;
a connector; and
a processor.

8. The smart tool board device of claim 7, wherein the RFID element is comprised of a sticker, a chip, a key fob, or a card.

9. The smart tool board device of claim 8, wherein the RFID element is positioned on a tool.

10. The smart tool board device of claim 9, wherein the RFID reader is in wireless electrical communication with the RFID element.

11. A smart tool board device comprising:
a body having an opening that is sized and configured to receive a peg;
a first light comprised of a first color LED;
a second light comprised of the first color LED;
a third light comprised of the first color LED;
a fourth light comprised of a second color LED;
a display;
an RFID reader;
an RFID element;
a connector; and
a processor.

12. The smart tool board device of claim 11, wherein the connector is comprised of a DB-9 female connector.

13. The smart tool board device of claim 11, wherein the first light illuminates a solid light.

14. The smart tool board device of claim 11, wherein the fourth light illuminates a solid light.

15. The smart tool board device of claim 11, wherein the fourth light illuminates the solid light when the RFID element is a first distance away from the RFID reader.

16. The smart tool board device of claim 11, wherein the fourth light illuminates a blinking light.

17. The smart tool board device of claim 11, wherein the third light illuminates a solid light when the RFID reader detects the RFID element.

18. The smart tool board device of claim 11, wherein the processor initiates a timer when the RFID reader does not detect the RFID element.

19. The smart tool board device of claim 11, wherein when the first light is illuminated the smart tool board device outputs a first voltage level via the processor.

20. The smart tool board device of claim 11, wherein when the fourth light is illuminated the smart tool board device outputs a second voltage level via the processor.
